(19) United States
(12) Patent Application Publication
(10) Pub. No.: US 2026/0045972 A1
(43) Pub. Date: Feb. 12, 2026

(54) METHOD AND DEVICE FOR TRANSMITTING AND RECEIVING SIGNAL IN WIRELESS COMMUNICATION SYSTEM

(71) Applicant: LG ELECTRONICS INC., Seoul (KR)

(72) Inventors: Jaeky OH, Seoul (KR); Jihwan JANG, Seoul (KR); Jaehoon CHUNG, Seoul (KR); Yecheng HE, Seoul (KR)

(73) Assignee: LG ELECTRONICS INC., Seoul (KR)

(21) Appl. No.: 19/101,245

(22) PCT Filed: Aug. 8, 2022
(86) PCT No.: PCT/KR2022/011771

§ 371 Date: Feb. 4, 2025

(51) Int. Cl. H04B 7/04; H04B 7/06

(52) U.S. Cl. CPC H04B 7/04026; H04B 7/0626

(57) ABSTRACT

The present disclosure may include, by a terminal in a wireless communication system, receiving a first reference signal transmitted from a base station, measuring a channel based on the first reference signal and generating first channel state information, receiving a second reference signal transmitted from the base station, measuring a channel based on the second reference signal and generating second channel state information, and receiving data through a first signal based on the first channel state information and the second channel state information. Herein, at least one of the first reference signal and the second reference signal may be transmitted to the terminal through a reconfigurable intelligent surface (RIS).

### CROSS-REFERENCE TO RELATED APPLICATION(S)

This application is the National Stage filing under 35 U.S.C. 371 of International Application No. PCT/KR2022/011771, filed on Aug. 8, 2022, the contents of which are all incorporated by reference herein in their entirety.

### TECHNICAL FIELD

The present disclosure relates to a wireless communication system, and more particularly, to a method and device for transmitting and receiving a signal by a terminal and a base station in a wireless communication system.

Specifically, the present disclosure may provide a method and apparatus by which a terminal and a base station transmit and receive a signal by controlling a radio channel environment through a reconfigurable intelligent surface (RIS).

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide a device and method for transmitting a signal in a wireless communication system.

The present disclosure may provide a method by which a terminal and a base station transmit and receive a signal by using a reconfigurable intelligent surface (RIS) in a wireless communication system.

The present disclosure may provide a method for controlling a RIS based on an artificial intelligence (AI) in a wireless communication system.

The present disclosure may provide a method for measuring a channel of a smart radio environment (SRE) in a wireless communication system.

The present disclosure may provide a method for performing beamforming suitable for an SRE in a wireless communication system.

The present disclosure may provide a method and apparatus by which a terminal and a base station transmit and receive a signal based on an SRE in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for operating a terminal in a wireless communication system may include receiving a first reference signal transmitted from a base station, measuring a channel based on the first reference signal and generating first channel state information, receiving a second reference signal transmitted from the base station, measuring a channel based on the second reference signal and generating second channel state information, and receiving data through a first signal based on the first channel state information and the second channel state information. At least one of the first reference signal and the second reference signal may be transmitted to the terminal through a reconfigurable intelligent surface (RIS).

In addition, as an example of the present disclosure, a method for operating a base station in a wireless communication system may include transmitting a first reference signal to a terminal, transmitting a second reference signal to the terminal, and transmitting data through a first signal based on first channel state information and second channel state information. The first channel state information and the second channel state information may be generated by the first reference signal and the second reference signal, and at least one of the first reference signal and the second reference signal may be transmitted to the terminal through a reconfigurable intelligent surface (RIS).

In addition, as an example of the present disclosure, a terminal in a wireless communication system may include a transceiver and a processor coupled with the transceiver. The processor may be configured to receive a first reference signal transmitted from a base station, to measure a channel based on the first reference signal and generate first channel state information, to receive a second reference signal transmitted from the base station, to measure a channel based on the second reference signal and generate second channel state information, and to receive data through a first signal based on the first channel state information and the second channel state information. At least one of the first reference signal and the second reference signal may be transmitted to the terminal through a reconfigurable intelligent surface (RIS).

In addition, as an example of the present disclosure, a base station in a wireless communication system may include a transceiver and a processor coupled with the transceiver. The processor may be configured to transmit a first reference signal to a terminal, to transmit a second reference signal to the terminal, and to transmit data through a first signal based on first channel state information and second channel state information. The first channel state information and the second channel state information may be generated by the first reference signal and the second reference signal, and at least one of the first reference signal and the second reference signal may be transmitted to the terminal through a reconfigurable intelligent surface (RIS).

In addition, as an example of the present disclosure, a device may include at least one memory and at least one processor functionally coupled with the at least one memory. The at least one processor may control the device to receive a first reference signal transmitted from a base station, to measure a channel based on the first reference signal and generate first channel state information, to receive a second reference signal transmitted from the base station, to measure a channel based on the second reference signal and generate second channel state information, and to receive data through a first signal based on the first channel state information and the second channel state information. At least one of the first reference signal and the second reference signal may be transmitted to the terminal through a reconfigurable intelligent surface (RIS).

In addition, as an example of the present disclosure, a non-transitory computer-readable medium storing at least one instruction may include the at least one instruction that is executable by a processor. The at least one instruction may be configured to receive a first reference signal transmitted from a base station, to measure a channel based on the first reference signal and generate first channel state information, to receive a second reference signal transmitted from the base station, to measure a channel based on the second reference signal and generate second channel state information, and to receive data through a first signal based on the first channel state information and the second channel state information. At least one of the first reference signal and the second reference signal may be transmitted to the terminal through a reconfigurable intelligent surface (RIS).

In addition, the following may be commonly applied.

In addition, as an example of the present disclosure, the first reference signal is a reference signal that is transmitted with all elements of the RIS being off, the base station transmits a first control signal that instructs the RIS to turn off all the elements of the RIS, the second reference signal is a reference signal that is transmitted with at least one of the RIS elements being on, and the base station may transmit a second control signal that instructs the RIS to turn on at least one of the RIS elements.

In addition, as an example of the present disclosure, the second control signal may be generated based on a learning result of a frequency rate according to a direction of the terminal.

In addition, as an example of the present disclosure, the second control signal may be information that is generated through a codebook based on a RIS direction vector set.

In addition, as an example of the present disclosure, third channel state information may be generated by the first channel state information and the second channel state information.

In addition, as an example of the present disclosure, the first channel state information may be state information for a direct channel, the second channel state information may be state information for an effective channel, and the third channel state information may be state information for a reflected channel.

In addition, as an example of the present disclosure, a first beamforming value and a second beamforming value may be calculated by using the first channel state information and the second channel state information, the first signal may be generated based on the calculated first beamforming value and the calculated second beamforming value, the first beamforming value may be a beamforming value of the base station, and the second beamforming value may be a beamforming value of the RIS.

In addition, as an example of the present disclosure, the terminal may include an integrated beamforming configurator to which an artificial intelligence (AI) technology is applied, and the first beamforming value and the second beamforming value may be calculated by the integrated beamforming configurator. In addition, as an example of the present disclosure, the integrated beamforming configurator may have inputs of state information and a reward value based on reinforcement learning and output an action, the state information may include the first channel state information and the second channel state information, the reward value may be a result for a control value of the RIS, and the action may be the first beamforming value and the second beamforming value.

As is apparent from the above description, the embodiments of the present disclosure have the following effects.

In the embodiments of the present disclosure, a channel measurement method according to a smart radio environment (SRE) may be provided.

In the present disclosure, channel measurement may be effectively performed by applying an artificial intelligence (AI) technology in a wireless communication system.

In the embodiments of the present disclosure, it is possible to provide a method for transmitting and receiving a signal by a terminal and a base station using a reconfigurable intelligent surface (RIS) in an SRE.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of an AI device applied to the present disclosure.

FIG. 5 is a view showing a radio channel environment according to an embodiment of the present disclosure.

FIG. 6 is a view showing a smart radio environment according to an embodiment of the present disclosure.

FIG. 7 is a view showing an existing radio channel environment and a smart radio environment according to an embodiment of the present disclosure.

FIG. 8 is a view showing a method for performing optimization in a smart radio environment according to an embodiment of the present disclosure.

FIG. 9 is a view showing a trust region according to an embodiment of the present disclosure.

FIG. 10 illustrates a RIS control sequence for radio channel measurement according to an embodiment of the present disclosure.

FIG. 11 illustrates an example of an SRE system including an integrated beamforming configurator according to an embodiment of the present disclosure.

FIG. 12 illustrates an example of a base station-RIIS-terminal signal diagram for channel estimation and integrated beamforming in an SRE according to an embodiment of the present disclosure.

FIG. 13 illustrates an example of a channel estimation and integrated beamforming procedure according to an embodiment of the present disclosure.

FIG. 14 illustrates an example of a base station-RIIS-terminal signal diagram for channel estimation and integrated beamforming in an SRE according to an embodiment of the present disclosure.

FIG. 15 illustrates an example of a channel estimation and integrated beamforming procedure according to an embodiment of the present disclosure.

FIG. 16 illustrates an example of an active RIS device according to an embodiment of the present disclosure.

FIG. 17 illustrates an example of a passive RIS device according to an embodiment of the present disclosure.

(a) of FIG. 18 illustrates an example of a metalens according to an embodiment of the present disclosure.

(b) of FIG. 18 illustrates an example of signal conversion according to a pattern of metalens according to an embodiment of the present disclosure.

(a) of FIG. 19 is a view exemplifying a frequency rate according to directivity of a RIS according to an embodiment of the present disclosure.

(b) of FIG. 19 is a view showing a beam direction according to directivity of a RIS according to an embodiment of the present disclosure.

FIG. 20 illustrates an example of a pattern setting procedure based on a frequency rate according to an embodiment of the present disclosure.

FIG. 21 illustrates an example of an artificial intelligence (AI) channel estimator according to an embodiment of the present disclosure.

FIG. 22 illustrates an example of an integrated beamforming configurator based on supervised learning according to an embodiment of the present disclosure.

FIG. 23 illustrates an example of an integrated beamforming configurator based on reinforcement learning according to an embodiment of the present disclosure.

FIG. 24 illustrates an example of a signal transmission/reception procedure of a terminal in an SRE according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

*Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

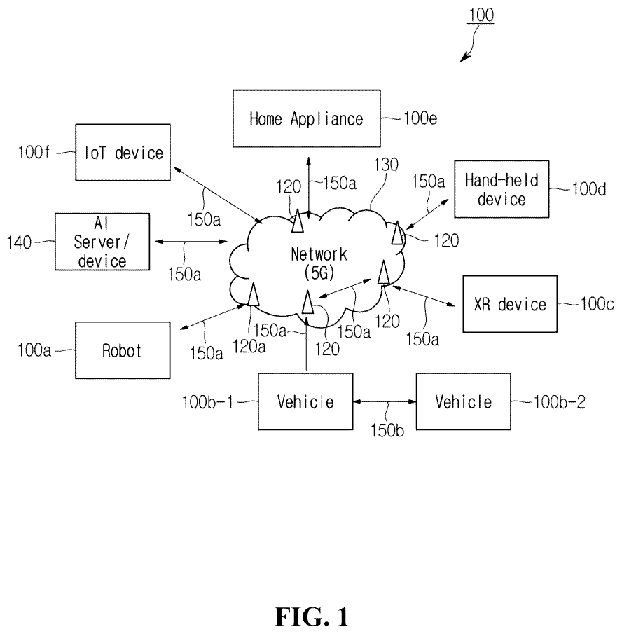

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

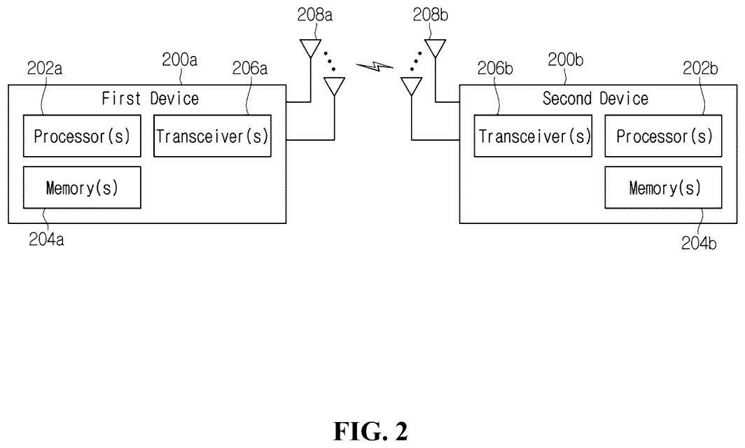

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

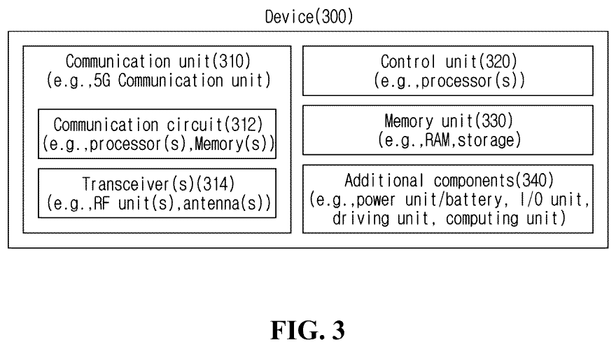

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

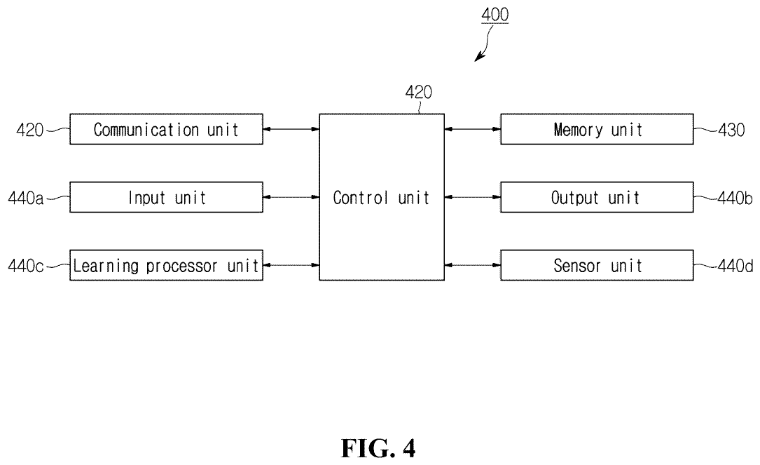

FIG. 4 illustrates an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 4, the AI device 400 may include a communication unit 410, a control unit 420, a memory unit 430, an input/output unit 440a/440b, a learning processor unit 440c and a sensor unit 440d. Blocks 410 to 430/440A to 440D may correspond to blocks 310 to 330/340 of FIG. 3, respectively.

The communication unit 410 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 410 may transmit information in the memory unit 430 to an external device or send a signal received from an external device to the memory unit 430.

The control unit 420 may determine at least one executable operation of the AI device 400 based on information determined or generated using a data analysis algorithm or machine learning algorithm. In addition, the control unit 420 may control the components of the AI device 400 to perform the determined operation. For example, the control unit 420 may request, search, receive, or utilize the data of the learning processor 440c or the memory unit 430, and control the components of the AI device 400 to perform predicted operation or operation determined to be preferred among at least one executable operation. In addition, the control unit 420 collects history information including a user's feedback on the operation content or operation of the AI device 400, and stores it in the memory unit 430 or the learning processor 440c or transmit it to an external device such as the AI server (140 in FIG. 1). The collected history information may be used to update a learning model.

The memory unit 430 may store data supporting various functions of the AI device 400. For example, the memory unit 430 may store data obtained from the input unit 440a, data obtained from the communication unit 410, output data of the learning processor unit 440c, and data obtained from the sensor unit 440. Also, the memory unit 430 may store control information and/or software code required for operation/execution of the control unit 420.

The input unit 440a may obtain various types of data from the outside of the AI device 400. For example, the input unit 420 may obtain learning data for model learning, input data to which the learning model is applied, etc. The input unit 440a may include a camera, a microphone and/or a user input unit, etc. The output unit 440b may generate audio, video or tactile output. The output unit 440b may include a display unit, a speaker and/or a haptic module. The sensor unit 440 may obtain at least one of internal information of the AI device 400, surrounding environment information of the AI device 400 or user information using various sensors. The sensor unit 440 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 440c may train a model composed of an artificial neural network using learning data. The learning processor unit 440c may perform AI processing together with the learning processor unit of the AI server (140 in FIG. 1). The learning processor unit 440c may process information received from an external device through the communication unit 410 and/or information stored in the memory unit 430. In addition, the output value of the learning processor unit 440c may be transmitted to an external device through the communication unit 410 and/or stored in the memory unit 430.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | |
|---|---|
| Per device peak data rate | 1 Tbps |
| EZE latency | 1 ms |
| Maximum spectral efficiency | 100 bps/Hz |
| Mobility support | Up to |
| | 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

Hereinafter will be described a method for controlling a radio channel environment by using a reconfigurable intelligent surface (RIS). In addition, the RIS may be an intelligent reflect surface (IRS). That is, there may be a various forms of RISs, and the present disclosure may not be limited to a specific term. Hereinafter, for convenience of explanation, the description will be mainly use RIS but may not be limited thereto. Herein, an artificial intelligence (AI) system may be used to control a radio channel environment using a RIS, which will also be described below.

As an example, the current wireless communication technology may be controlled through endpoint optimization that adapts to a channel environment H. As an example, when optimization is performed in a transmitter and a receiver, the transmitter and the receiver may improve transfer efficiency by adjusting at least any one of beamforming, power control, and adaptive modulation according to the channel environment H between the transmitter and the receiver.

At this time, the channel environment may be random, not controlled, and in a naturally fixed state. That is, in an existing communication system, a channel environment has a fixed state, and each endpoint may be controlled to be optimized to the channel environment. Accordingly, a transmitter and a receiver have no choice but to perform optimization to adapt to a channel and thus transmit and receive data. Herein, in a non-line of sight (NLOS) environment of a shadow area or in an environment which has a large signal loss and hardly has multiple paths, such as 6G THz, the optimization of endpoints may not overcome the Shannon's capacity limit, and a throughput thus obtained may hardly satisfy an expected requirement.

In consideration of what is described above, in a new communication system, communication may be performed based on a smart radio environment. Herein, in the smart radio environment, a RIS may be used as a factor capable of controlling a radio channel like a transceiver.

That is, a factor for a radio channel may be added as an available factor for optimizing wireless communication transmission. Thus, channel reconfiguration or Shannon's capacity limit, which are insoluble problems of the existing communication system, may be overcome. However, it is necessary to measure a channel added by a RIS in a smart radio environment and to perform optimization in simultaneous consideration of the RIS together with a transceiver, and an optimization process may become complicated.

As an example, along with the current limitations of wireless communication technology, an alternating optimization (AO) algorithm applied in a smart radio environment may have limitations on controlling a RIS.

More specifically, an existing communication system may be operated by approaching Shannon's capacity limit through the control of a transmitter and a receiver in a fixed radio channel environment. However, in a poor NLOS environment like a shadow area, transmission and reception may be actually impossible because of channel capacity limit. As an example, in a NLOS environment, a transmitter may improve the channel capacity limit by increasing power, but the magnitude of noise and interference may also increase to that extent. Herein, in an environment that has a large signal loss and hardly has multiple paths, optimization of a transmitter and a receiver alone may have limitations on overcoming Shannon's capacity limit.

Herein, as an example, a new communication system (e.g. 6G) may need to satisfy requirements for providing new services such as MBRLLC (Mobile Broadband Reliable Low Latency Communication), mURLLC (Massive Ultra-Reliable, Low Latency communications), HCS(Human-Centric Services), and 3CLS(Convergence of Communications, Computing, Control, Localization, and Sensing), and to this end, communication based on a smart radio environment may be needed.

In addition, as an example, a lot of relays are being used to increase the cell coverage of a base station and to support a shadow area. However, although using relays may improve transmission efficiency, an additional interference signal may occur to other users. Accordingly, there may be a limitation on overall efficiency of communication resources. In addition, a high additional cost and energy are required to use relays, and complex and mixed interference signals may not be easy to manage. In addition, as an example, spectrum efficiency may be reduced by using a half-duplex scheme, and this may affect space usage and aesthetics.

On the other hand, in a smart radio environment, a radio channel environment may be controlled by using a RIS. At the same time, a transmitter and a receiver may perform optimization together to provide a solution to overcoming Shannon's capacity limit in a smart radio environment, which will be described below.

However, apart from an existing channel between a base station and a terminal, a base station-RIS channel and a RIS-terminal channel also need to be considered. In addition, optimization of a transceiver is sufficient in an existing environment, but a smart radio environment requires to control a RIS together.

In addition, a corresponding value may have dependency on optimization of a transceiver, and complexity may increase accordingly. Herein, an alternating optimization (AO) algorithm used for optimization may be iteratively implemented until convergence and cause a burden of measuring every channel. In consideration of what is described above, hereinafter will be described a method for performing optimization by a reconfigurable intelligence surface (RIS) in a smart radio environment and an artificial intelligence (AI) system.

In addition, as an example, Table 2 may present terms that consider what is described above and will be described below, and based on this, hereinafter will be a method for performing optimization by a RIS in a smart radio environment and an AI system.

TABLE 2
Federated learning
Reconfigurable intelligent surface (RIS)
Intelligent reflect surface (IRS)
Smart radio environment
Mobile broadband reliable low latency communication
(MBRLLC): 6G service requiring high speed,
high reliability and low latency (e.g. BCI)
Massive machine type communication (mMTC)
Massive ultra-reliable, low latency communications (mURLLC):
mMTC + URLLC
Quality-of-physical-experience (QoPE):
QOS + QOE + physiological reaction
Human-centric services (HCS): communication based on QoPE
Convergence of communications, computing, control,
localization, and sensing (3CLS)

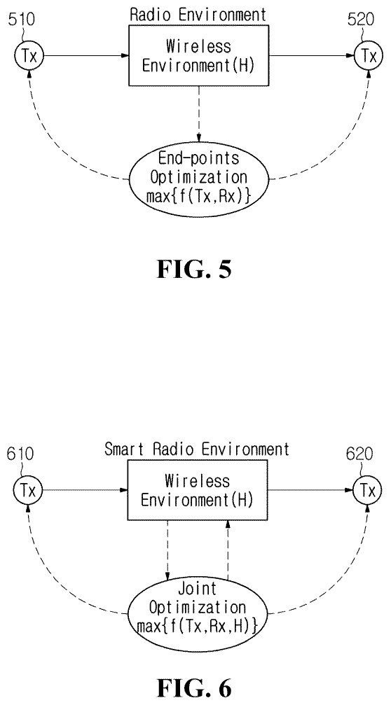

FIG. 5 is a view showing a radio channel environment according to an embodiment of the present disclosure. Referring to FIG. 5, in an existing communication system, a radio channel environment H may be naturally fixed and be an uncontrollable random state. Accordingly, a transmitter 510 and a receiver 520 may find an optimized transmitting and receiving method that is adaptive to a channel. The transmitter 510 and the receiver 520 may be controlled to measure a channel state through a signal (e.g. reference signal) and perform optimization based on the measured channel state. However, as described above, there may be a limitation of data transfer in a case with a large signal loss and having a difficulty in applying multiple paths, such as THz environment, and a NLOS environment such as a shadow area. As an example, Equation 1 below may show Shannon's capacity limit. Herein, even when augmenting a transmission signal P by applying precoding and processing in Equation 1, if the channel |H| has a small size, there may be a limitation in increasing a channel capacity.

In a fixed state of radio channel environment, there may be a limitation in increasing a channel capacity based on Equation 1. Herein, multiple paths between the transmitter 510 and the receiver 520 may be secured by using a RIS, and thus the above-described channel |H|, may be increased. That is, in a smart radio environment, a radio channel environment based on a RIS may be a controllable factor, and thus the channel capacity may be increased.

$$C = log ( 1 + \frac{\vert HP {\vert}^{2}}{{σ}^{2}} ) \qquad [ Equation 1 ]$$

As an example, FIG. 6 is a view showing a smart radio environment according to an embodiment of the present disclosure. Referring to FIG. 6, a wireless channel |H| in a smart radio channel may be a factor for optimization. More specifically, in FIG. 5 described above, as endpoint optimization, optimization may be performed in a transmitter 610 and a receiver 620 based on “max{f(Tx, Rx)}”, and this is the same as described above. However, in FIG. 6, as endpoint optimization, optimization may be performed in the transmitter 610 and the receiver 620 based on “max{f(Tx, Rx, H)}”. That is, in a smart radio environment, the channel |H| may be used based on a RIS as a factor for optimization.

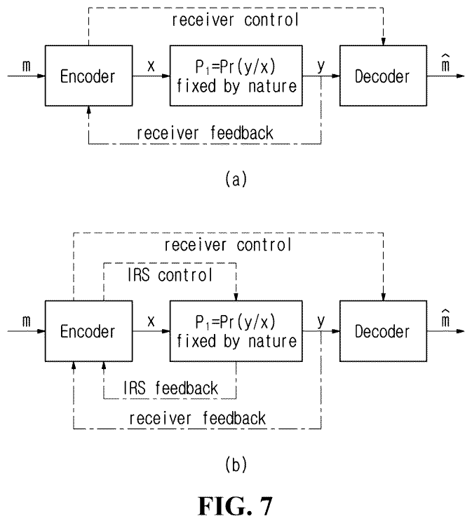

FIG. 7 is a view showing an existing radio channel environment and a smart radio environment according to an embodiment of the present disclosure. As an example, referring to (a) of FIG. 7, the existing radio channel environment may be P1. In addition, referring to (b) of FIG. 7, the smart radio environment may be P2. Herein, in (a) of FIG. 7 and (b) of FIG. 7, when a signal x is transmitted from a transmitter through a wireless channel, a receiver may receive a signal y. Herein, in the existing radio channel environment, a probability of P1 may be fixed, the receiver (decoder) may transmit feedback to the transmitter through measurement for a transmission signal. The transmitter may perform optimization to adapt to a radio channel environment through the feedback of the receiver. As a more concrete example, a receiver may measure a channel quality indicator (CQI) for a transmission signal based on a reference signal transmitted from a transmitter and give feedback thereon. The transmitter may control a modulation coding scheme (MCS) based on the feedback information and provide information on it, thereby performing communication.

On the other hand, referring to (b) of FIG. 7, in a smart radio environment, a radio channel environment P2 is recognized, and the radio channel environment may be modified through RIS control. At the same time, a receiver may measure a received transmission signal and transmit feedback on it to a transmitter. That is, the transmitter may receive feedback information based on RIS control and feedback information of the receiver and perform optimization. Herein, the transmitter may modify a radio channel environment by controlling a RIS, and optimization may be performed by considering the radio channel environment and the transmitter.

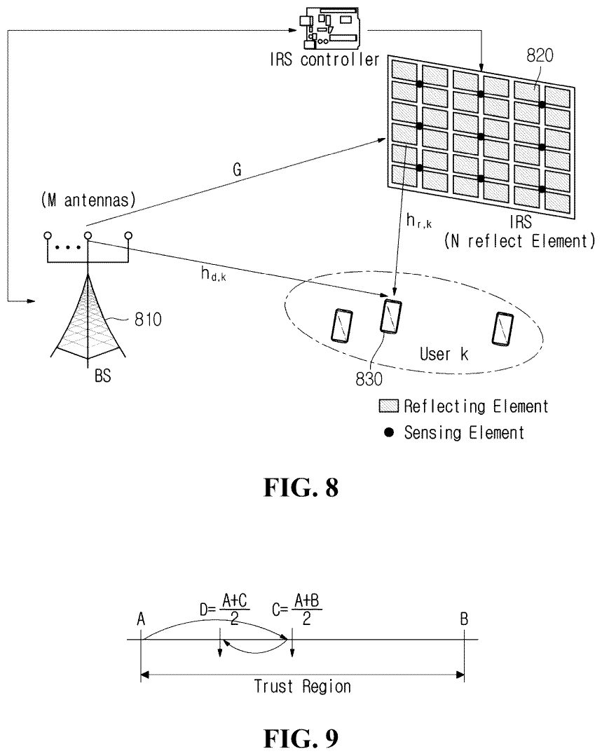

More specifically, FIG. 8 is a view showing a method for performing optimization in a smart radio environment according to an embodiment of the present disclosure. Referring to FIG. 8, in a smart radio environment, there may be a RIS 820 between a base station 810 and a terminal 830. As an example, there may be a path, in which a signal transmitted by the base station 810 is directly transmitted to the terminal 830, and a path in which the signal is transmitted by reflecting from the RIS 820. That is, a smart radio environment may have a wireless channel G between the base station 810 and the RIS 820, a wireless channel h_{r,k} between the RIS 820 and the terminal 830, and a direct wireless channel between the base station 810 and the terminal 830. Herein, based on control of the RIS 820, the wireless channel G between the base station 810 and the RIS 820 and the wireless channel h_{r,k} between the RIS 820 and the terminal 830 may be modified. Accordingly, optimization in a smart radio environment may be performed by considering the above-described radio channel environment.

More specifically, in case the base station 810 transmits a signal to the terminal k 830, a base station transmit beamforming vector for the terminal k 830 may be wₖ, the signal transmitted to the terminal k 830 may be sₖ, and a reception noise may be nₖ. Herein, a signal, which the terminal k 830 receives from the base station 810 based on an environment using the RIS 820, may be represented by Equation 2 below, and each channel may be shown in Table 3.

$$y = ( {k}_{r , k} Φ G + {h}_{d , k} ) {w}_{k} {s}_{k} + {n}_{k} \qquad [ Equation 2 ]$$

```
TABLE 3
  h_{d,k} ϵ [symbol] ^{1×M}: Channel from BS to user k, h_{r,k} ϵ [symbol] ^{1×N}: Channel from IRS to
user k
  G ϵ [symbol] ^{N×M}: Channel from BS to IRS, wₖ ϵ [symbol] ^{M×1}: transmit beamforming
vector for signal sₖ
  Φ = diag(β1e [symbol]  ... βNe [symbol] ): Phase and amplitude coefficient for element
n, β ϵ [0,1], 0 ϵ [0, 2π]
  nₖ ~ CN (0, σ²ₖ): AWGN at user k [symbol]
indicates data missing or illegible when filed
```

Here, a signal noise ratio (SNR) received by the terminal k 830 may be represented by Equation 3 below.

$$γ = \frac{( {h}_{r , k} Φ G + {h}_{d , k} ) {w}_{k}}{{σ}_{k}^{2}} \qquad [ Equation 3 ]$$

Accordingly, when an SRE for optimizing a received SNR is constructed, it may be a case of setting control of an IRS and transmit beamforming, as shown in Equation 4 below.

$${max}_{{w}_{k} , Φ} \frac{{\vert ( {h}_{r , k} Φ G + {h}_{d , k} ) {w}_{k} \vert}^{2}}{{σ}_{k}^{2}} \qquad [ Equation 4 ]$$

Here, considering maximum-rate transmit in MIMO, transmit beamforming wₖ of the terminal k 1230 may be represented by Equation 5 below.

$${w}_{k}^{*} = \sqrt{{P}_{max}} \frac{{( {h}_{r , k} Φ G + {h}_{d , k} )}^{H}}{‖ ( {h}_{r , k} Φ G + {h}_{d , k} ) ‖} \qquad [ Equation 5 ]$$

Here, pₘₐₓ may be a maximum transmission power in an IRS, and if

$$\text{?}$$

$$\text{?} \text{indicates text missing or illegible when filed}$$

is put into an equation maximizing wₖ and ϕ, optimization may be represented by Equation 6 below.

$${max}_{Φ} {‖ {h}_{r , k} Φ G + {h}_{d , k} ‖}^{2} , s . t . \vert {Φ}_{i , i} \vert = 1 , ∀ i = 1 , 2 , 3 , … , N \qquad [ Equation 6 ]$$

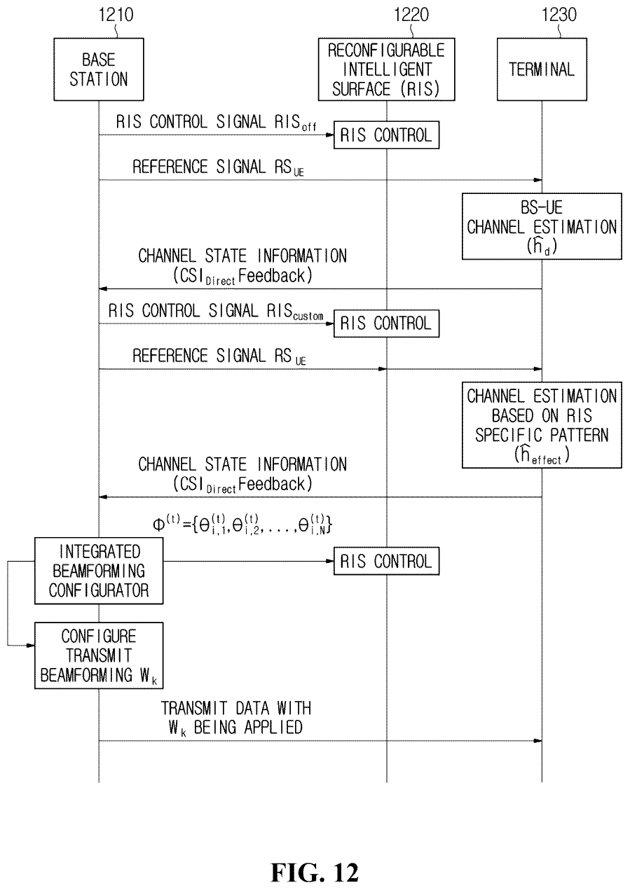

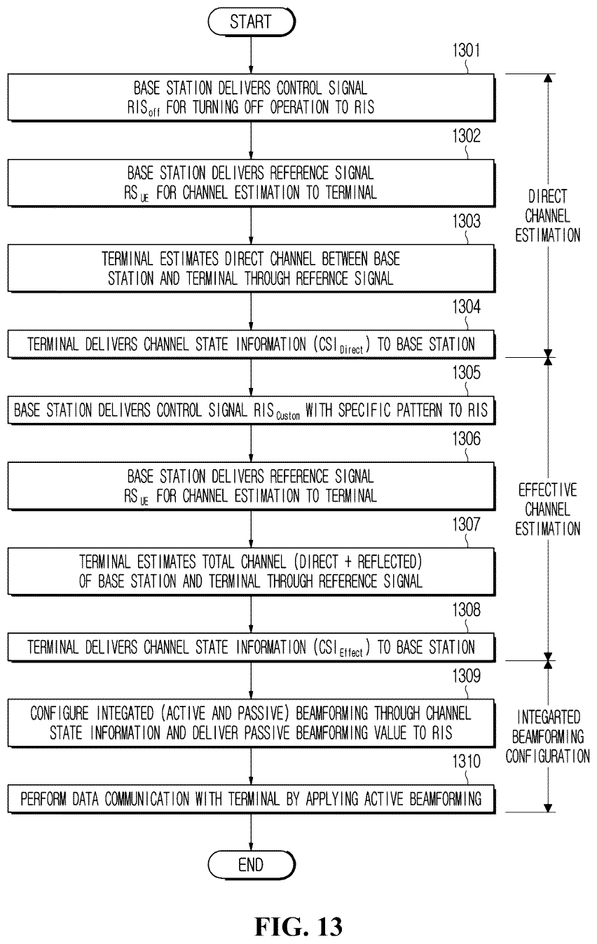

Herein, when the IRS control value ϕ is determined, wₖ may be determined by an operation. Herein, an alternating optimization (AO) algorithm may be used to solve the above-described optimization problem. As an example, the AO algorithm may be a method of determining a trust region for each IRS element by using channel information (h_{d}, hᵣ, G), as shown in FIG. 13. In addition, a binary decision may be made iteratively until values of an objective function (objective values) converge, and thus θₙ may be obtained. Herein, when an upper bound of a convergence value is an ideal IRS, βₙ(θₙ) may be equal to 1. Herein, as an example, in FIG. 12, an IRS may repeat the above-descried operation in order to find an optimized value for each IRS element described above.

Herein, the AO algorithm needs to be repeated until convergence. In addition, as an optimized value should be derived for each IRS element, complexity may increase and a computational quantity may increase. Herein, the complexity and the computational quantity may be increase according to the number N of antennas and the number of IRS elements in a base station, and there may be a limitation in calculating them. In addition, when the AO algorithm is optimized, measured values of all the channels including IRSs may be needed, and considering what is described above, there may be a limitation on optimization.

As described in FIG. 8, in a smart radio environment (SRE), there may be a direct channel h_{d,k} between a base station and a terminal and a reflected radio channel h_{r,k}ϕG (hereinafter, ‘reflected channel’) passing through base station-RIS-terminal. The direct channel h_{d,k} may be measured based on a reference signal that is transmitted while all RIS elements are off. The reflected channel h_{r,k}ϕG may be measured based on a reference signal that is transmitted while at least one of the RIS elements is on.

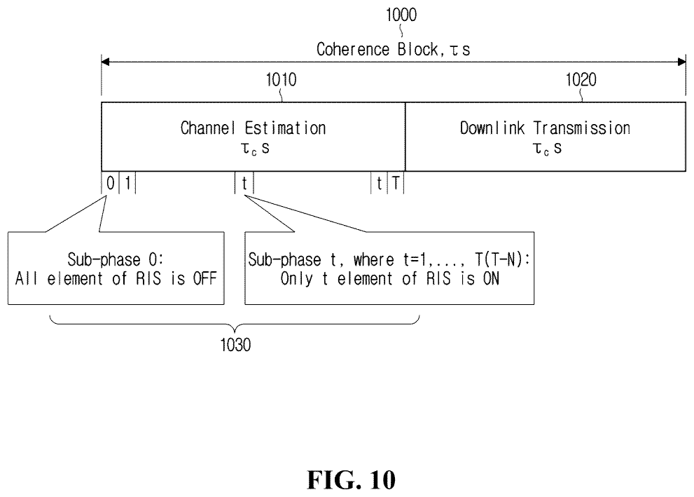

As an example, FIG. 10 illustrates a RIS control sequence for radio channel measurement according to an embodiment of the present disclosure. Referring to FIG. 10, a coherence block segment Ts 1000 may include a channel estimation segment τ_{c}s 1010 and a downlink transmission segment τ_{d}s 1020. Herein, the channel estimation segment 1010 may include T+1 sub-phases 1030. A RIS may be controlled according to each sub-phase. As an example, in case a sub-phase is 0, all the elements of the RIS may be off. In addition, each time the sub-phase changes, the elements of the RIS may be alternately turned on one by one. When all the elements of the RIS are off, a terminal may measure the direct channel h_{d,k}, and each time the elements of the RIS are alternately turned on, the terminal may measure the reflected channel h_{r,k}ϕG. Then, a measurement result of channel may be transmitted through the downlink transmission segment 1020.

Meanwhile, the above-described channel measurement method may take a lot of time because a channel estimation process is performed for a total of T+1 sub-phases. In addition, as the reflected channel h_{r,k}ϕG is measured with only one element being on, the strength of a received signal for measurement is weak, which leads to disadvantages of vulnerability to noise and difficulty of securing reliability.

Accordingly, as described above, the present disclosure proposes a signal transmission and reception method for solving the problem caused by an increasing number of RIS elements in an SRE. Specifically, the present disclosure proposes a method for performing channel estimation and integrated beamforming by controlling a RIS with an AI technology. Herein, the integrated beamforming is a concept encompassing active beamforming and passive beamforming. Active beamforming is beamforming that a base station performs to transmit and receive a signal, and passive beamforming is beamforming that a RIS performs to reflect a signal.

According to the present disclosure, as channel measurement for a RIS is simplified through RIS control, the channel estimation time may be minimized. In addition, by applying an AI technology, channel estimation and integrated beamforming may be performed without restriction on the number of antennas (M) of a base station and the number of RIS elements (N). In addition, according to an embodiment of the present disclosure, when a specific RIS pattern reflecting a structural characteristic of a building or facility is used, a channel gain may be increased, which may provide an advantage of enabling noise-resistant channel estimation.

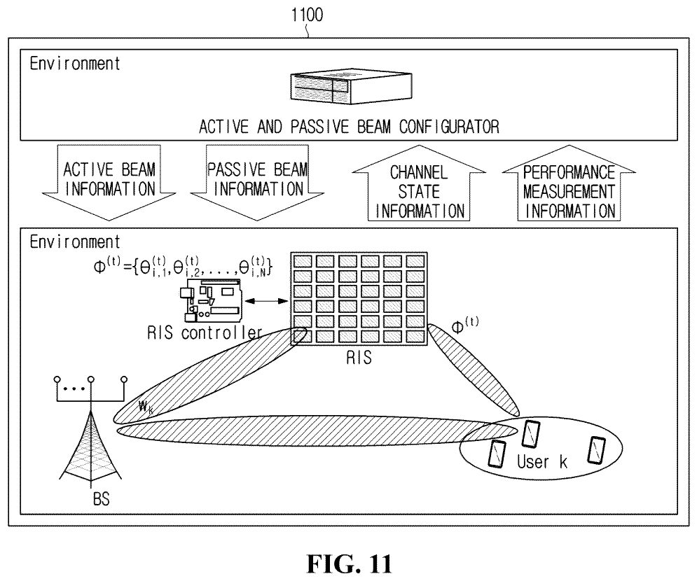

FIG. 11 illustrates an example of an SRE system (hereinafter, ‘system’) 1100 including an integrated beamforming configurator according to an embodiment of the present disclosure.

Referring to FIG. 11, it is possible to identify the system 1100 in which an active beam and a passive beam are configured based on a channel estimation result in an SRE. From the perspective of reinforcement learning, an active and passive beam configurator may be represented as agent, and an SRE including a RIS and a base station/terminal may be represented as environment. The agent may deliver active beam information and passive beam information to the environment and obtain channel state information and performance measurement information from the environment. Herein, as the agent, the active and passive beam configurator may perform a channel estimation operation and a data transmission operation in the SRE. In the channel estimation phase, the active and passive beam configurator may obtain the channel state information and the performance measurement information by controlling beamforming wₖ of the RIS ϕ and the base station. Thus, optimal active beam information and passive beam information are determined for the base station, the RIS and the terminal, and data transmission may be performed in an optimal radio channel environment accordingly. Additionally, performance measurement information obtained based on a data transmission result in the optimal radio channel environment may be used for learning.

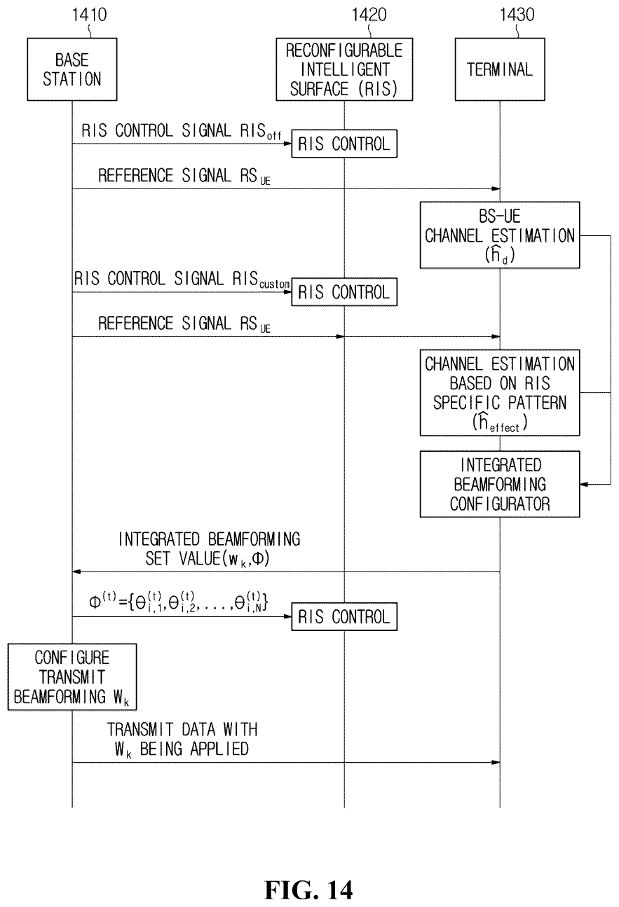

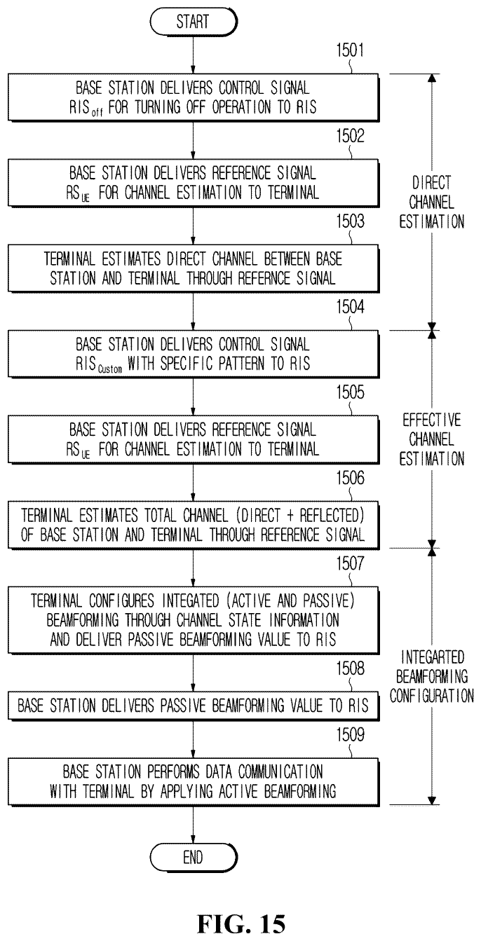

Hereinafter, an integrated beamforming procedure based on a channel estimation procedure and a channel estimation result in an SRE will be described. FIG. 12 and FIG. 13 illustrate an example of signal flow among a base station, a RIS and a terminal, when an integrated beamforming configurator is located in the base station. FIG. 14 and FIG. 15 illustrate an example of signal flow among a base station, a RIS and a terminal, when an integrated beamforming configurator is located in the terminal.

FIG. 12 illustrates an example of a base station 1210—RIS 1220—terminal 1230 signal diagram for channel estimation and integrated beamforming in an SRE according to an embodiment of the present disclosure.

Referring to FIG. 12, the base station 1210 may transmit a RIS control signal (e.g., RIS_{off}) (hereinafter, ‘RIS off signal’), which instructs the RIS 1220 to turn off all the elements of the RIS 1220, to the RIS 1220. The RIS 1220 may turn off all the elements based on the received RIS off signal. Next, the base station 1210 may transmit a reference signal (e.g., RS_{UE}). As all the elements of the RIS 1220 are turned off by the RIS off signal, the terminal 1230 may estimate a direct channel ĥ_{d} between the base station 1210 and the terminal 1230 based on the reference signal transmitted by the base station 1210. Next, the terminal 1230 may transmit direct channel state information (e.g., CSI_{Direct}), which is a direct channel estimation result, to the base station 1220.

Meanwhile, for integrated beamforming in an SRE, not only a direct channel but also a reflect channel by the RIS 1220 needs to be estimated. As the direct channel ĥ_{d} between the base station 1210 and the terminal 1230 is always present, it may be impossible to directly measure only a base station 1210—RIS 1220—terminal 1230 reflected channel. Thus, the reflected channel may be estimated using a correlation among an effective channel, a direct channel and a reflected channel. The effective channel is a concept encompassing the direct channel and the reflected channel. The relationship among the effective channel, the direct channel and the reflected channel may be expressed by Equation 7 below. In Equation 7, h_{effect} is an effective channel value, hᵣ is a reflected channel value between the RIS 1220 and the terminal 1230, and h_{d} is a direct channel value. According to Equation 7, the reflected channel value may be estimated by subtracting a measured value of the direct channel from a measured value of the effective channel.

$${h}_{effect} = {h}_{r} Φ G + {h}_{d} \qquad [ Equation 7 ]$$

That is, in order to measure the reflected channel, the effective channel should be measured first. Accordingly, the base station 1210 may transmit a RIS control signal (e.g., RIS_{Custom}) (hereinafter, ‘RIS custom signal’) to the RIS 1220. The RIS custom signal may include RIS pattern information. The RIS pattern information may indicate the on/off state of each of the elements of the RIS 1220. The RIS 1220 may control on/off of the elements based on the RIS pattern information, adjust a reflective index (equation of permittivity and permeability), thereby changing a focal length or a focal position. That is, the RIS 1220 may configure a pattern of the RIS 1220 based on the RIS pattern information received from the base station 1210.

Herein, as an example, the base station 1210 may determine RIS pattern information such that the strength of a reference signal reflected from the RIS 1220 and transmitted to the terminal 1230 may be maximized. Meanwhile, because the base station 1210 does not know a position of the terminal 1230 during initial operation, the base station 1210 may determine RIS pattern information such that a signal reflected by the RIS 1220 may become a square wave that is transmissible in every direction. In addition, the RIS pattern information may be updated according to a user's frequency count such that it may reflect a real environment such as a building or a structure. As an example, pattern information may be determined such that a signal is not transmitted to a position with a user's low use frequency count and the signal is transmitted more strongly to a position with a higher frequency count.

When the pattern of the RIS 1220 is configured, the base station 1210 may transmit a reference signal (e.g., RS_{UE}). In this case, as at least one element of the RIS is on according to the pattern information included in the RIS custom signal, the reference signal may be reflected by the RIS 1220 and transmitted to the terminal 1230. Accordingly, the terminal 1230 may estimate an effective channel ĥ_{effect} based on the reference signal reflected by the RIS 1220 on which the specific pattern is configured. Next, the terminal 1230 may calculate the reflected channel by subtracting a direct channel measured value ĥ_{d} from an effective channel measured value ĥ_{effect}. Herein, as shown in Equation 8 below, the terminal 1220 may use a pattern information value ϕ to estimate a reflected serial channel Hᵣ excluding the control value of the RIS 1220.

$${h}_{r} Φ G = {vH}_{r} , ν = [ {β}_{1} {e}^{j {θ}_{1}} , … , {β}_{N} {e}^{j {θ}_{N}} ] , {H}_{r} = diag ( {h}_{r} ) G \qquad [ Equation 8 ]$$

As described above, the terminal 1230 may estimate the direct channel ĥ_{d} and the effective channel ĥ_{effect} and calculate the reflected channel, thereby obtaining state information for each of the channels. Next, the terminal 1230 may transmit channel state information CSI_{effect} for the direct channel ĥ_{d} and the reflected channel ĥ_{effect} to the base station 1210. Based on the channel state information CSI_{effect}, an integrated beamforming configurator located in the base station 1210 may calculate an active beamforming value to be performed in the base station 1210 and a passive beamforming value to be performed in the RIS 1220. Herein, channel state information, which is not obtained by effective channel measurement, may be supplemented through an AI technology.

Next, a RIS control signal

$${Φ}^{( t )} = \{ {θ}_{i , 1}^{( t )} , {θ}_{i , 2}^{( t )} , … , {θ}_{i , N}^{( t )} \}$$

including passive beamforming value information may be transmitted to the RIS 1220. The RIS 1220 may apply a passive beamforming value based on the RIS control signal. The base station 1210 may apply an active beamforming value and transmit and receive data through a configured passive beamforming and active beamforming environment.

FIG. 13 illustrates an example of a channel estimation and integrated beamforming procedure according to an embodiment of the present disclosure. Referring to FIG. 13, the procedure may be divided into a direct channel estimation step (S1301 to S1304), an effective channel estimation step (S1305 to S1308), and an integrated beamforming step (S1309 to S1310). At step S1301, a base station may transmit a RIS control signal RIS_{off} that instructs a RIS to terminate operation. The RIS may turn off all elements based on the RIS control signal. At step S1302, the base station may transmit a reference signal RS_{UE} for channel estimation to a terminal. At step S1303, the terminal may estimate a direct channel between the base station and the terminal based on the reference signal RS_{UE}. As all the RIS elements are off, there is no impact of a reflected channel. At step S1304, the terminal may transmit channel state information CIS_{Direct} as a direct channel estimation result to the base station.

Next, an effective channel estimation procedure for reflected channel estimation may be performed. At step S1305, the base station may transmit a control signal including pattern information CIS_{Direct} (hereinafter, ‘RIS custom signal’) to the RIS. The RIS may configure a pattern of the RIS by controlling on/off of the RIS elements based on the RIS custom signal. When the RIS pattern is configured, at step S1306, the base station may transmit a reference signal RS_{IE}. for channel estimation to the terminal. The reference signal may be reflected by the RIS according to the configured pattern and be delivered to the terminal or delivered directly to the terminal without the RIS. At step S1307, the terminal may estimate an effective channel based on the received reference signal RS_{UE}. The terminal may calculate the reflected channel based on a measured direct channel and a measured effective channel. At step S1308, the terminal may transmit state information CIS_{effect} of each of the measured channels to the base station.

Next, the base station may calculate, based on the state information of the channels, an active beamforming value to be applied by the base station and a passive beamforming value to be applied to the RIS. That is, at step S1309, the base station may determine integrated beamforming information based on the channel state information CIS_{effect}. The integrated beamforming information may include the active beamforming value and the passive beamforming value. The base station may transmit the determined passive beamforming information to the RIS. The RIS may apply the beamforming value based on the received passive beamforming information. At step S1310, the base station may perform data communication with the terminal by applying the active beamforming value. In FIG. 13, the RIS control signal and the integrated beamforming information may be transmitted also in a codebook form. In addition, the order of the direct channel estimation step and the effective channel estimation step may be changed.

Meanwhile, an integrated beamforming configurator may be located in a base station, as shown in FIG. 12 and FIG. 13, but it may also be implemented in a terminal. In case integrated beamforming information is determined in a terminal, the terminal may not transmit state information for each measured channel to a base station. In addition, as the terminal determines the integrated beamforming information, the terminal should transmit active beamforming information or passive beamforming information to the base station or a RIS. In this case, an advantage of determining beamforming information by considering state information of the terminal (e.g., position information, movement information) may be provided. FIG. 14 and FIG. 15 below illustrate an example of signal flow among a base station, a RIS and a terminal, when an integrated beamforming configurator is implemented in the terminal.

FIG. 14 illustrates an example of a base station 1410—RIS 1420—terminal 1430 signal diagram for channel estimation and integrated beamforming in an SRE according to an embodiment of the present disclosure.

Referring to FIG. 14, the base station 1410 may transmit a RIS control signal (e.g., RIS_{off}) (hereinafter, ‘RIS off signal’), which instructs the RIS 1420 to turn off all the elements of the RIS, to the RIS 1420. The RIS 1420 may turn off all the elements based on the received RIS off signal. Next, the base station 1410 may transmit a reference signal (e.g., RS_{UE}) to the terminal 1430. As all the elements of the RIS 1420 are turned off by the RIS off signal, the terminal 1430 may estimate a direct channel ĥ_{d} between the base station 1410 and the terminal 1430 based on the reference signal transmitted by the base station 1410.

In addition, the base station 1410 may transmit a RIS control signal (e.g., RIS_{Custom}) (hereinafter, ‘RIS custom signal’) to the RIS 1420. The RIS 1420 may configure a pattern of the RIS 1420 based on RIS pattern information included in the RIS custom signal.

When the pattern of the RIS 1420 is configured, the base station 1410 may transmit a reference signal (e.g., RS_{UE}). In this case, as at least one element of the RIS is on according to the pattern information included in the RIS custom signal, the reference signal may be reflected by the RIS 1420 and transmitted to the terminal 1430. Accordingly, the terminal 1430 may estimate an effective channel ĥ_{effect} based on the reference signal reflected by the RIS 1420 on which a specific pattern is configured. Next, the terminal 1430 may calculate the reflected channel by subtracting a direct channel measured value d from an effective channel measured value ĥ_{effect}.

As described above, the terminal 1430 may estimate a direct channel and an effective channel and calculate a reflected channel, thereby obtaining state information for each of the channels. Then, the terminal 1430 may determine an integrated beamforming set value (wₖ, ϕ) by using an integrated beamforming configurator. The integrated beamforming set value (wₖ, ϕ) may include an active beamforming value (wₖ) and a passive beamforming value (ϕ) that are calculated based on the state information of each channel measured by the terminal. Next, data communication may be performed by applying the determined integrated beamforming set value (wₖ, ϕ).

As an example, the terminal may transmit the integrated beamforming set value (wₖ, ϕ) to the base station. The base station may transmit the passive beamforming value (ϕ) to the RIS. Herein, the passive beamforming value may be transmitted in a codebook form

$$( {Φ}^{( t )} = \{ {θ}_{i , 1}^{( t )} , {θ}_{i , 2}^{( t )} , … , {θ}_{i , N}^{( t )} \} ) .$$

As another example, the terminal may transmit the passive beamforming value (ϕ) directly to the RIS. The base station may apply the active beamforming value (wₖ) received from the terminal, and the RIS may apply the passive beamforming value (ϕ) received from the base station.

FIG. 15 illustrates an example of a channel estimation and integrated beamforming procedure according to an embodiment of the present disclosure.

Referring to FIG. 15, the procedure may be divided into a direct channel estimation step (S1501 to S1503), an effective channel estimation step (S1504 to S1506), and an integrated beamforming step (S1507 to S1509). At step S1501, a base station may transmit a RIS control signal RIS_{off} that instructs a RIS to terminate operation. The RIS may turn off all elements based on the RIS control signal. At step S1502, the base station may transmit a reference signal RS_{UE} for channel estimation to a terminal. At step S1503, the terminal may estimate a direct channel between the base station and the terminal based on the reference signal RS_{UE}. As all the RIS elements are off, there may be no impact of a reflected channel.

Next, an effective channel estimation procedure for reflected channel estimation may be performed. At step S1504, the base station may transmit a control signal including pattern information RIS_{Custom} (hereinafter, ‘RIS custom signal’) to the RIS. The RIS may configure a pattern of the elements by controlling on/off of the RIS elements based on the RIS custom signal. When the RIS pattern is configured, at step S1505, the base station may transmit a reference signal RS_{UE} for channel estimation to the terminal. The reference signal may be reflected by the RIS according to the configured pattern and be delivered to the terminal or delivered directly to the terminal without the RIS. At step S1506, the terminal may estimate an effective channel based on the received reference signal RS_{UE}. The terminal may calculate the reflected channel based on a measured direct channel and a measured effective channel. Herein, the order of the direct channel estimation step and the effective channel estimation step may be changed.

Next, the terminal may calculate, based on the state information of the channels, an active beamforming value to be applied by the base station and a passive beamforming value to be applied by the RIS. That is, at step S1507, the terminal may determine integrated beamforming information based on the channel state information. The integrated beamforming information may include the active beamforming value and the passive beamforming value. At step S1508, the terminal may transmit the integrated beamforming information to the RIS. The RIS may perform beamforming configuration based on the received passive beamforming information. At step S1509, the base station may perform data communication with the terminal by applying the active beamforming value.

As described above, an SRE optimization method through RIS control may be divided into three steps, including a direct channel estimation step, an effective channel estimation step, and an integrated beamforming configuration step. Hereinafter, a control signal and a device according to each step will be described.

At the direct channel estimation step, estimation of a direct channel between a base station and a terminal should be performed without being affected by an operation of a RIS, and thus a control function of the RIS needs to be implemented (e.g., a control signal indicating that a reflection function of the RIS is off).

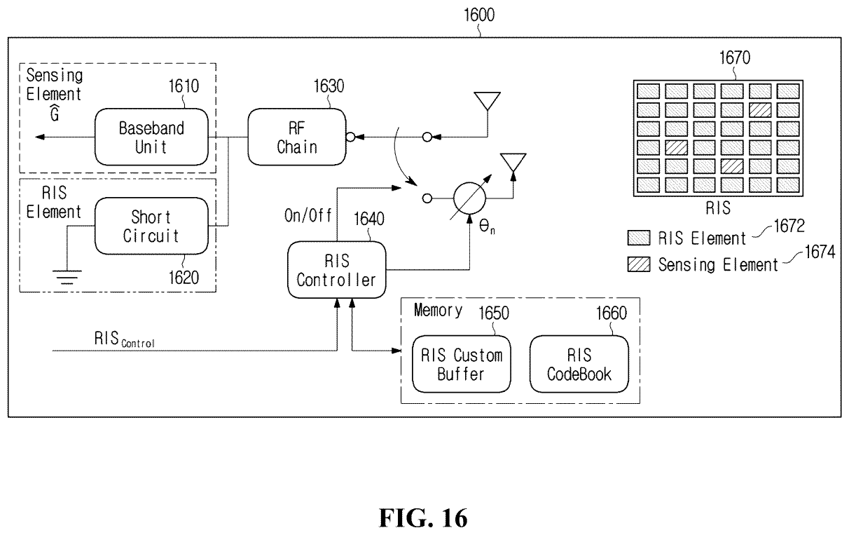

FIG. 16 illustrates an example of an active RIS device 1600 according to an embodiment of the present disclosure.

Referring to FIG. 16, the active RIS device 1600 may include a baseband unit 1610, a short circuit 1620, a radio frequency (RF) chain 1630, and a RIS controller 1640. An active RIS 1670 used in the active RIS device 1600 may include a RIS element 1672 capable of reflecting a signal and a sensing element 1674 capable of receiving a signal. The short circuit 1620 may be connected to the RIS element 1672 to control on/off of the RIS element 1672. The sensing element 1610 may be connected to the baseband unit 1610 to receive a signal. The active RIS 1670 further includes the sensing element 1674 capable of receiving a signal, as compared with a passive RIS. Accordingly, the active RIS 1670 may receive a signal unlike the passive RIS that merely reflects a signal. As an example, at the direct channel estimation step, the active RIS device 1600 may receive a control signal indicating the off of RIS (hereinafter, ‘RIS-off signal’). Herein, the sensing element 1674 may be changed to a signal reception state through the RF chain 1630 and the baseband unit 1610. Based on the received RIS-off signal, the active RIS device 1600 may not reflect a signal by shorting the RIS element 1672. Herein, when the base station transmits a reference signal, the terminal may receive the reference signal without being affected by the RIS and thus estimate a direct channel between the base station and the terminal. Additionally, the active RIS device 1600 may store a codebook for a RIS control value (RIS codebook) 1650 or a RIS custom buffer 1660 storing a RIS control value for effective channel measurement in a memory.

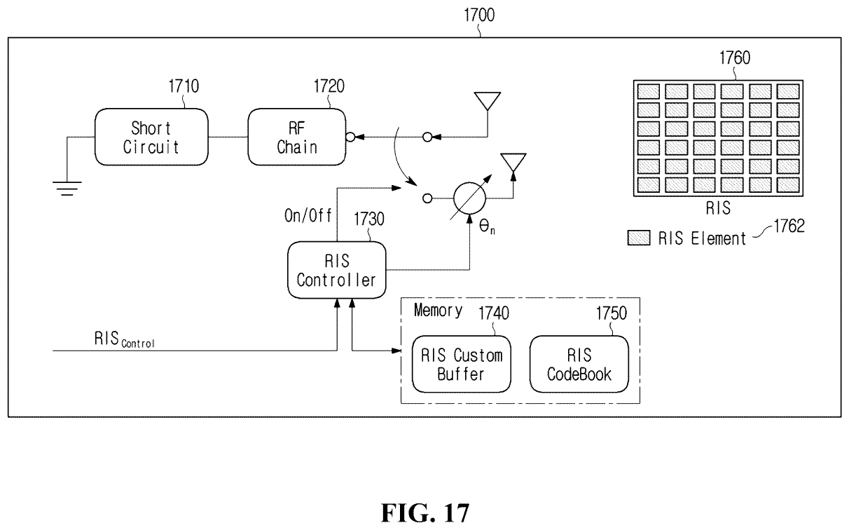

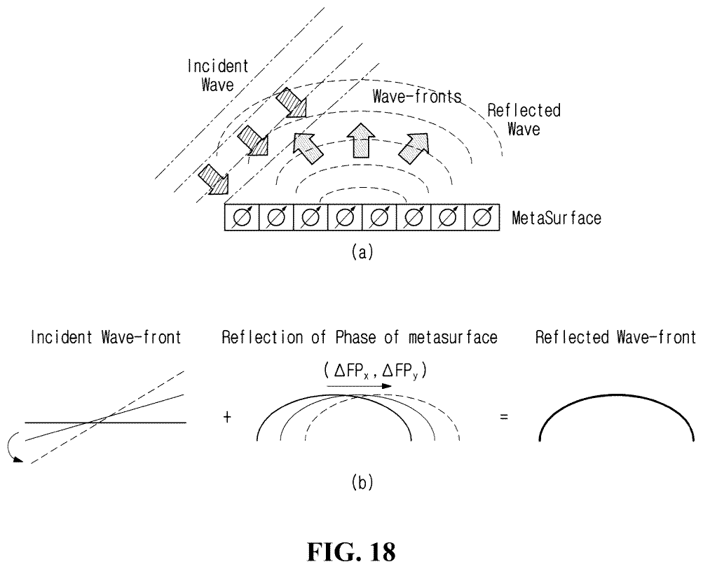

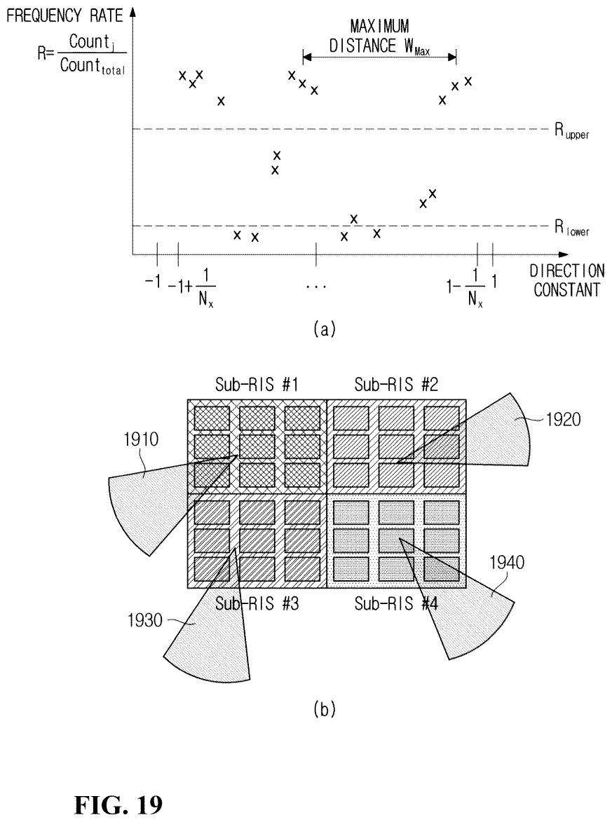

FIG. 17 illustrates an example of a passive RIS device according to an embodiment of the present disclosure.

Referring to FIG. 17, the passive RIS device 1700 may include a short circuit 1710, a RF chain 1720, and a RIS controller 1730. Unlike an active RIS device (e.g., ‘active RIS device’ 1600 of FIG. 16), as the passive RIS device 1700 does not include any sensing element, it may not include any baseband unit. Meanwhile, like an active RIS device, the passive RIS device 1700 may be used to estimate a direct channel. As an example, when the passive RIS device 1700 receives a RIS-off signal, the passive RIS device 1700 may turn off the reflection function of a RIS 1760 by using the short circuit 1710. As an example, at a direct channel estimation step, when the passive RIS device 1700 receives a control signal that instructs to turn off the RIS, a RIS element 1762 may be connected to the short circuit and not reflect a signal. Herein, when a base station transmits a reference signal, a terminal may receive the reference signal without being affected by the RIS and thus estimate a direct channel between the base station and the terminal. Additionally, the passive RIS device 1700 may store a codebook for a RIS control value (RIS codebook) 1750 or a RIS custom buffer 1760 storing a RIS control value for effective channel measurement in a memory.

As described above, when estimation is completed for a direct channel, estimation for an effective channel may be performed. At an effective channel estimation step, a terminal may estimate the effective channel by using a reference signal transmitted from a base station, while a RIS is configured with a specific pattern based on a RIS control value received from the base station. In order for the terminal to correctly estimate a channel, a reference signal with a predetermined strength level should be transmitted from the base station.

Meanwhile, at initial access, measurement may be performed for M*N channels. Here, M is the number of beamformings of a base station, and N is the number of beamformings of a RIS. Herein, if a pattern of the RIS is configured to transmit a received signal in every direction, a terminal may perform measurement only M times, that is, the number of beamformings of the base station. In this case, channel information may lack compared to M*N measurements performed by the terminal, but the speed and accuracy of channel measurements may be improved by applying an AI technology.

Hereinafter, a RIS configurable in a specific pattern will be described. For convenience of explanation, a metamaterial surface (hereinafter, ‘metalens’) will be described as an example, but the present disclosure is not limited to the embodiment described herein. That is, a RIS may have various forms and not be limited to a specific term.

(a) of FIG. 18 illustrates an example of a metalens according to an embodiment of the present disclosure.

Referring to (a) of FIG. 18, a most basic pattern of a metalens is shown to convert a plane wave into a spherical wave. Through the pattern, the metalens may transmit a signal in every direction. As an example, because a base station and the metalens are distant from each other, a signal transmitted from the base station may be received as a plane wave on the metalens. As there is no information on the position and direction of a terminal during initial access, the metalens may have a pattern configured to reflect a signal in every direction.

As an example, (b) of FIG. 18 illustrates an example of signal conversion according to a pattern of metalens according to an embodiment of the present disclosure. Referring to (b) of FIG. 18, a metalens may convert a plane wave into a spherical wave by setting a different control value according to an incident direction of the plane wave. Herein, the control value may be expressed as Δ(FPₓ, FP_{y}) but is not limited to a specific embodiment. Here, FPₓ may be an x-axis focal position, and FP_{y} may be a y-axis focal position. A direction of an incident wave may be expressed by a focal position, and the focal position may be predicted by using a sensor or by referring to a transmit beamforming value of a reference signal delivered from a base station. A specific pattern of a RIS may be configured by considering the above-described focal position.

In addition, a pattern may be determined based on frequency rate learning according to a direction of a terminal. As an example, a plane wave is converted into a spherical wave based on a RIS, but there may be a direction in which wave propagation is unnecessary in a building (e.g., building walls, ceilings, furniture). That is, for a specific region, wave propagation may be unnecessary or its frequency needs to be low, and for such a specific region, a high frequency rate may be set. Considering what is described above, a pattern may be configured by reflecting a frequency rate learning rate according to a direction of a terminal.

As an example, FIG. 19 is a view exemplifying a frequency rate and a beam direction according to directivity of a RIS according to an embodiment of the present disclosure. Referring to (a) of FIG. 19, Nₓ is the number of elements of a metalens in the direction of x-axis, and for the angles of metalens directivity, −90° and 90° may be represented as constants of −1 and 1 respectively. However, this is merely one example, and the present disclosure may not be limited to the above-described embodiment. Herein, if the beam direction is indicated at a spacing of

$$\frac{180 °}{{N}_{x}} ,$$

directivity may be represented by the following constant of

$${a}_{x} ( i ) = - 1 + \frac{2 i - 1}{{N}_{x}} ,$$

i∈{1, 2, 3, . . . , Nₓ}. In addition, a beam width may also be indicated at the spacing of

$$\frac{180 °}{{N}_{x}} .$$

Herein, if Nₓ is 4, a direction spacing may be 45°, aₓ(0), aₓ(1), aₓ(2), and aₓ(3) may represent −67.5°, −22.5°, 22.5° and 67.5° respectively, and a beam width may also be 45°

$$( = \frac{180 °}{4} ) .$$

In addition, the frequency rate R may be expressed by Equation 9 below.

$$R = \frac{{Count}_{j}}{{Count}_{total}} \qquad [ Equation 9 ]$$

Here, the frequency rate R may be expressed as a ratio of a count of direction index j Countⱼ to a total measurement count Countₜₒₜₐₗ. Rᵤₚₚₑᵣ and R_{low} may mean an upper bound limit and a lower bound limit of the frequency rate. As an example, among values of the frequence rate R, frequency rate values below the lower bound limit may be neglected. In addition, among frequency rate R values, a maximum distance W_{Max} may be measured for a direction constant with a frequency rate above the upper bound limit. As an example, as beam interference occurs with a beam width exceeding W_{Max}, W_{Max} may be an upper bound limit of beam width. Herein, based on what is described above, multiple beams 1910, 1920 and 1930 of a RIS may be configured in a sub-array form as shown in (b) of FIG. 19. Herein, if the RIS is composed of M sub-arrays, a beam width may be expressed by Equation 10 below.

$$Beam Width = \frac{2 M}{{N}_{x}} \qquad [ Equation 10 ]$$

Herein, when the number of sub-arrays M increases, the beam width may increase. However, if beam widths increase and overlap, interference may occur. Herein, as the maximum distance W_{Max} is the upper bound limit of beam width for a direction constant with a frequency rate, the upper bound limit of the number of sub-arrays M may be expressed by Equation 11 below.

$${W}_{Beam} \leq {W}_{Max} ⇒ M \leq \frac{{W}_{Max} {N}_{x}}{2} \qquad [ Equation 11 ]$$

As an example, if the value of M increases, the beamforming gain may decrease, and the size of a signal received at a terminal may also decrease. That is, if the number of sub-arrays increases, a signal received at a terminal may become weak.

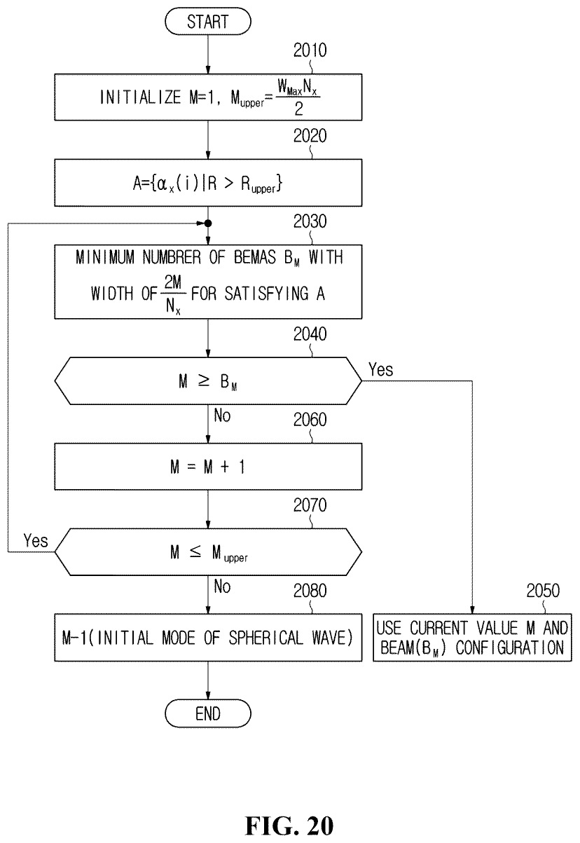

Herein, FIG. 20 illustrates an example of a pattern setting procedure based on a frequency rate according to an embodiment of the present disclosure. Referring to FIG. 20 the number of sub-arrays and a beam used herein may be set according to a frequency rate. As an example, the number of sub-arrays M may be initialized to 1, and an upper bound limit may be set by Equation 12 below (S2010).

$${M}_{upper} = \frac{{W}_{Max} {N}_{x}}{2} \qquad [ Equation 12 ]$$

Herein, a set A of direction constant αₓ(i) with a frequency rate exceeding Rᵤₚₚₑᵣ may be set (S2020). Next, by increasing M, a minimum number of beams B_{M} with a width

$$\frac{2 M}{{N}_{x}}$$

satisfying A may be obtained (S2030). That is, while increasing the number of sub-arrays, it is possible to obtain a minimum number of beams. Herein, if the number of sub-arrays is greater than or equal to a minimum number of required beams B_{M} (S2040), the value of M and the beam B_{M} may be set (S2050). An initial recognition mode of a metalens may be configured according to the number of sub-arrays M and the beam B_{M}. On the other hand, if M is increased and is smaller than B_{M} (S2040), the value of M may be increased (S2060). Herein, the value of M may be set not to exceed the upper bound limit Mᵤₚₚₑᵣ, that is, a maximum number of sub-arrays (S2070). That is, if M is smaller than Mᵤₚₚₑᵣ (S2070), it is possible to check whether an increased M is greater than B_{M}, and this is the same as described above. On the other hand, if no beam is found until M is equal to Mᵤₚₚₑᵣ (S2070), M may be set to 1 (S2080). That is, a sub-array may be configured to use a spherical wave that is uniform in every direction, and an initial setting may be determined based on what is described above.

In addition, as an example, at an effective channel estimation step, a terminal may measure a combined channel of a base station-RIIS-terminal serial reflected channel and a base station-terminal direct channel by using pattern information configured in the RIS. As another example, at a direct channel estimation step, a terminal may estimate a serial reflected channel. The estimation operations may be performed using Equation 7 and Equation 8. In addition, estimation processes for each channel may be performed based on an AI technology.

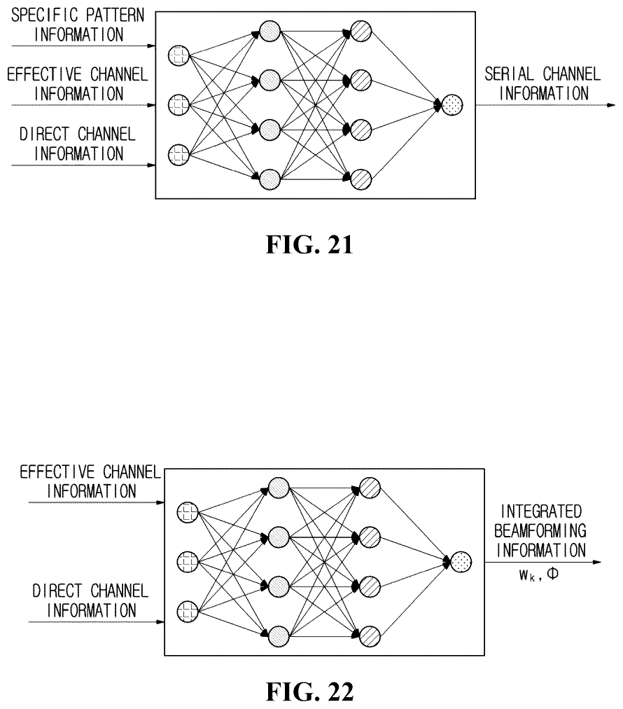

FIG. 21 illustrates an example of an artificial intelligence (AI) channel estimator according to an embodiment of the present disclosure.

Referring to FIG. 21, an AI channel estimator may obtain serial channel information through specific pattern information, effective channel information and direct channel information. Herein, the specific pattern

$${Φ}^{( t )} = \{ {θ}_{i , 1}^{( t )} , {θ}_{i , 2}^{( t )} , … , {θ}_{i , N}^{( t )} \}$$

may be expressed by a control value of a RIS. One or more pieces of specific pattern information may be used, and as the number of pieces of specific pattern information increases, measured effective channel information may increase. Accordingly, when more pieces of specific pattern information are used, accurate serial channel information may be obtained, but the time required for channel measurement and the size of an AI system may increase.

In addition, a base station may transmit a message including specific pattern information to a RIS. As an example, the RIS may store the received specific pattern information in a memory (e.g., the RIS custom buffer 1650 of FIG. 16, the RIS custom buffer 1740 of FIG. 17) or store the received specific pattern information as a codebook with a set index. As another example, the RIS may store direction information of an incident wave, which is represented as a focal position Δ(FPₓ, FP_{y}), in a codebook with a combined form with a spherical wave of a reflected wave or a beam.

When estimation is completed for a direct channel and an effective channel, the terminal may obtain reflected channel information based on a result of the direct channel and the effective channel. Then, an integrated beamforming configuration procedure may be performed based on state information of the direct channel and the reflected channel.

To configure integrated beamforming, an optimal value of ϕ may be obtained from Equation 6. In addition, wₖ may be determined by putting the value of ϕ into Equation 5. wₖ is an active beamforming value, and ϕ is a passive beamforming value. In order to calculate the optimal ϕ value based on measured channel state information by Equation 6, it needs to be expressed in the form of a serial reflected channel of Equation 8. That is, if Equation 8 is put into Equation 6, the result may be expressed as shown in Equation 13 below.

$$\begin{matrix}{max}_{Φ} {‖ {vH}_{r} + {h}_{d , k} ‖}^{2} , s . t . {H}_{r} = diag ( {h}_{r} ) G , \\ v = [ {β}_{1} {e}^{j {θ}_{1}} , … , {β}_{N} {e}^{j {θ}_{N}} ] {∀}_{i} = 1 , 2 , 3 , … , N\end{matrix} \qquad [ Equation 13 ]$$

In Equation 13, an optimal value v may be calculated by using the values of a serial reflected channel Hᵣ and a direct channel h_{d,k} that are obtained through a channel measurement step performed prior to the beamforming configuration step. v may be calculated through an alternating optimization (AO) algorithm or semidefinite relaxation (SDR). After calculating the passive beamforming value ϕ, the terminal may put ϕ into Equation 5 to calculate an optimal active beamforming value wₖ with respect to maximum-rate transmit.

As an example, a passive beamforming value may be expressed as a codebook, and thus the computational load of an AI model and the transmission volume of a control signal may be minimized. Herein, a direction vector function, which represents an array response vector in a reception direction, may be expressed by Equation 14 below.

$$u ( ω , N ) = {[ 1 , {e}^{- j π \cdot 1 \cdot ω} , {e}^{- j π \cdot 2 \cdot ω} , … , {e}^{- j π \cdot N \cdot ω} ]}^{T} \qquad [ Equation 14 ]$$

In Equation 14, N may be a size of an array (antenna or IRS element), and w may be a phase different between antennas or IRS elements.

As an example, a received response vector aᵣ(Øᵣ, θᵣ) for a signal, which a RIS receives from a base station based on beamforming, may be expressed by a direction vector function u(ω,N) as shown in Equation 15 below.

$$\begin{matrix}{a}_{r} ( {∅}_{r} , {θ}_{r} ) = u ( {φ}_{r} , {N}_{x} ) ⊗ u ( {ϑ}_{r} {N}_{y} ) \\ {φ}_{r} = \frac{2 d}{λ} cos ( {∅}_{r} ) sin ( {θ}_{r} ) , {ϑ}_{r} = \frac{2 d}{λ} cos ( {θ}_{r} ) , {φ}_{r} , {ϑ}_{r} ∈ [ - \frac{2 d}{λ} , \frac{2 d}{λ} ]\end{matrix} \qquad [ Equation 15 ]$$

In Equation 15, Øᵣ may be an azimuth of IRS, θᵣ may be an elevation angle, Nₓ and N_{y} may be the horizontal and vertical numbers of IRS elements respectively, and ⊗ may represent a Kronecker product. In addition, a transmitted response vector bₜ(Øₜ, θₜ) of IRS may also be expressed by a direct vector function u(ω,N) as shown in Equation 16 below.

$$\begin{matrix}{b}_{t} ( {∅}_{t} , {θ}_{t} ) = u ( {φ}_{t} , {N}_{x} ) ⊗ u ( {ϑ}_{t} , {N}_{y} ) \\ {φ}_{t} = \frac{2 d}{λ} cos ( {∅}_{t} ) sin ( {θ}_{t} ) , {ϑ}_{t} = \frac{2 d}{λ} cos ( {θ}_{t} )\end{matrix} \qquad [ Equation 16 ]$$

In addition, for a transmission signal xₖ to which a transmission beamforming is applied, a signal through IRS may be expressed by Equation 17 below.

$$y = ( {h}_{r , k} Φ G ) {x}_{k} + {n}_{k} = {gh}_{k} \cdot {b}_{t}^{H} ( {∅}_{t} , {θ}_{t} ) Φ {a}_{r} ( {∅}_{r} , {θ}_{r} ) {x}_{k} + {n}_{k} = {gh}_{k} {c}_{k}^{H} {vx}_{k} + {n}_{k} \qquad [ Equation 17 ]$$

In Equation 17,

$$G = g \cdot {a}_{r} ( {∅}_{r} , {θ}_{r} ) , {h}_{r , k} = {h}_{k} \cdot {b}_{t}^{H} ( {∅}_{t} , {θ}_{t} ) ,$$

g may be a path gain of a BS-IRS channel, and hₖ may be a path gain of an IRS-UE channel. In addition, ϕ is a phase value matrix of IRS elements and may be expressed by ϕ=diag(v), v=[e^{jω}^{₁},e^{jω}^{₂}, . . . , e^{jω}^{_{N}}]. In addition,

$${c}_{k}^{H} = {b}_{t}^{H} ( {∅}_{t} , {θ}_{t} ) ⊙ {a}_{r} ( {∅}_{r} , {θ}_{r} ) .$$

Here, ⊙ is a Hadamard product representing an element-wise product of a matrix, which may be expressed by Equation 18.

$$\begin{matrix}{c}_{k}^{H} = {b}_{t}^{H} ( {∅}_{t} , {θ}_{t} ) ⊙ {a}_{r} ( {∅}_{r} , {θ}_{r} ) \\ = ( {u}^{H} ( {φ}_{t} , {N}_{x} ) ⊗ {u}^{H} ( {ϑ}_{t} , {N}_{y} ) ) ⊙ ( {u}^{T} ( {φ}_{r} , {N}_{x} ) ⊗ {u}^{T} ( {ϑ}_{r} , {N}_{y} ) ) \\ = ( {u}^{H} ( {φ}_{t} , {N}_{x} ) ⊙ {u}^{T} ( {φ}_{r} , {N}_{x} ) ) ⊗ ( {u}^{H} ( {ϑ}_{t} , {N}_{y} ) ⊙ {u}^{T} ( {ϑ}_{r} , {N}_{y} ) ) \\ = u ( {\tilde{φ}}_{k} , {N}_{x} ) ⊗ u ( {\tilde{ϑ}}_{k} , {N}_{y} ) \\ {\tilde{φ}}_{k} = {φ}_{t} - {φ}_{r} , {\tilde{ϑ}}_{k} = {ϑ}_{t} - {ϑ}_{r} , {\tilde{φ}}_{k} , {\tilde{ϑ}}_{k} ∈ [ - \frac{4 d}{λ} , \frac{4 d}{λ} ]\end{matrix} \qquad [ Equation 18 ]$$

In Equation 18, as u(ω, N) is a function with a period of φₖ=\tilde{φ}ₖ mod 2, φₖ=φₖ mod 2 may be possible, and

$${c}_{k}^{H} = u ( {φ}_{k} , {N}_{x} ) ⊗ u ( {ϑ}_{k} , {N}_{y} ) ,$$

φₖ, \tilde{φ}ₖ∈{−1, 1} may be possible.

In addition, an optimal beamforming vector v of IRS, which maximizes a received signal SNR, is cₖ and may be expressed by a Kronecker product of direction vector functions u(ω,N) of an azimuth and an elevation angle.

That is, an IRS control value may be managed in the form of an azimuth and an elevation angle, and a control value according to each direction may be managed as a codebook. As an example, a codebook \tilde{W}(j)={\tilde{w}(1), \acute{w}(2), . . . , w(J)} is a set of IRS direction vectors and may have the sizes of \tilde{w}ₓ(j)∈C^{N}^{ₓ}^{×1}, \tilde{w}_{y}(j)∈C^{N}^{_{y}}^{×1} respectively in horizontal and vertical directions. In addition, j belongs to J (j∈J) and an index of a direction vector, and J may be every representable direction vector. As an example, J is a value indicating the number of beams in horizontal and vertical directions and may be expressed differently by Jₓ, J_{y} in horizontal and vertical directions respectively.

Herein, a beam configured by a final AI beam selector may be expressed by Equation 20 based on Equation 19.

$$\begin{matrix}{\tilde{W}}_{x} ( i ) = u ( {α}_{x} ( i ) , {N}_{x} ) , {\tilde{W}}_{y} ( i ) = u ( {α}_{y} ( j ) , {N}_{y} ) , \\ {α}_{x} ( i ) = - 1 + \frac{2 i - 1}{{J}_{x}} , {α}_{y} ( j ) = - 1 + \frac{2 j - 1}{{J}_{y}} \\ i ∈ \{ 1 , 2 , 3 , … , {J}_{x} \} , j ∈ \{ 1 , 2 , 3 , … , {J}_{y} \}\end{matrix} \qquad [ Equation 19 ]$$

$$\tilde{W} ( i , j ) = {\tilde{W}}_{x} ( i ) ⊗ {\tilde{W}}_{y} ( j ) = u ( {φ}_{i} , {N}_{x} ) ⊗ u ( {ϑ}_{j} , {N}_{y} ) \qquad [ Equation 20 ]$$

That is, an integrated beam configurator may express a beam through a codebook as described above, and thus an AI model may be simplified. In addition, an integrated beamforming configurator may determine an integrated beamforming value by using an AI technology (e.g., supervised learning, reinforcement learning).

FIG. 22 illustrates an example of an integrated beamforming configurator based on supervised learning according to an embodiment of the present disclosure. Referring to FIG. 22, an integrated beamforming configurator may determine integrated beamforming information (wₖ, ϕ) based on an effective channel estimation result and a direct channel estimation result. As an example, the integrated beamforming configurator may be trained in various environments, and learning data may include a result derived through an SDR or an AO algorithm in a simulation environment. Based on a learning result, the integrated beamforming configurator may determine the integrated beamforming information (wₖ, ϕ) quickly and accurately with a low computational load. As another example, the integrated beamforming configurator may improve accuracy of beamforming information through transfer learning of difference from real data. The integrated beamforming information may be stored in a form of codebook or raw data.

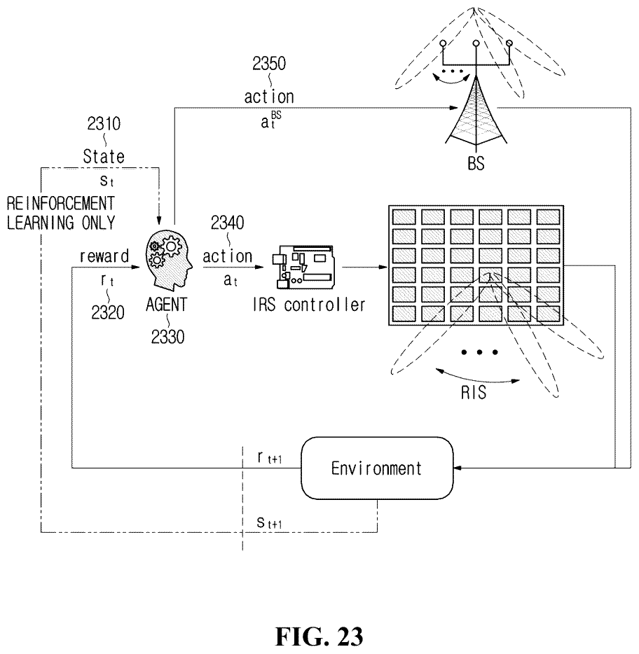

FIG. 23 illustrates an example of an integrated beamforming configurator based on reinforcement learning according to an embodiment of the present disclosure. Referring to FIG. 23, an integrated beamforming configurator may perform learning based on reinforcement learning. Herein, as an example, the reinforcement learning may consist of two inputs and one output. An agent 2330 may use a reward value 2320 of state information 2310 as an input and select actions 2340 and 2350 as outputs. Herein, as an example, the reinforcement learning may be multi-armed bandit (MAB), and MAB may not use state information but is not limited thereto. In addition, as outputs, the actions 2340 and 2350 may be an operation of a RIS controller to select a beam that provides an optimal communication environment to a terminal. As an example, the integrated beamforming configurator may obtain the reward value 2320 and the modified state information 2310 for the actions 2340 and 2350 from the environment and use them for learning. In addition, the integrated beamforming configurator may repeat the operation of selecting the actions 2340 and 2350 again based on an input following the learning. An integrated beamforming configurator based on reinforcement learning may be implemented not only as the agent 2330 but also as multi-agents that configure active beamforming and passive beamforming respectively.

As an example, the state information 2310 is a factor obtained from environment and may include direct channel information, effective channel information and received SNR information. In order to determine a passive beamforming value and an active beamforming value, a change of environment needs to be reflected in the state information 2310. In order to reflect the change of environment in the state information 2310, power information of each received signal is needed, and thus SNR information may be needed. SNR may be replaced by an indirect indicator (e.g., CQI, f_{MSE}) indicating a channel state. Equation 21 below exemplifies state information according to factors.

$${s}_{t} = \{ ( {SNR}_{d , k} , {SNR}_{eff , k} , {\hat{h}}_{d , k} , {\hat{h}}_{eff , k} , \} \qquad [ Equation 21 ]$$

$$\begin{matrix}{a}_{t} = ( {a}_{t}^{BS} , {a}_{t}^{RIS} ) = ( ( {i}_{x} , {j}_{y} ) , ( {i}_{x} , {j}_{y} ) ) , \\ {i}_{x} ∈ \{ 1 , 2 , 3 , … , {J}_{x} \} , {j}_{y} ∈ \{ 1 , 2 , 3 , … , {J}_{y} \}\end{matrix} \qquad [ Equation 22 ]$$

In Equation 22, aₜ is a value that is determined based on a codebook in a base station and a RIS, and the indexes of an azimuth and an elevation angle of a direction vector may be actually selected by an AI. An action may include an active beamforming value

$${a}_{t}^{BS}$$

of the base station and a passive beamforming value

$${a}_{t}^{RIS}$$

of the RIS. As an example, the action may be implemented by selecting an index of a codebook represented as a direction vector. In addition, a beamforming value of the base station and a phase shift values of RIS elements may be applied to the action.

The reward value 2320 is a value measured by a terminal and may be a result for a control value selected by a base station and a RIS. The reward value 2320 may be transmitted to a place in which an integrated beamforming configurator is located (e.g., the terminal, the base station, the RIS). As an example, the terminal may calculate the reward value 2320 by applying a weight through a RIS performance measuring device. As another example, if the RIS performance measuring device is not used, the reward value 2320 may be expressed by Equation 23 below.

$${r}_{t} = {R}^{t} = SNR or {f}_{MSE} or CQI \qquad [ Equation 23 ]$$

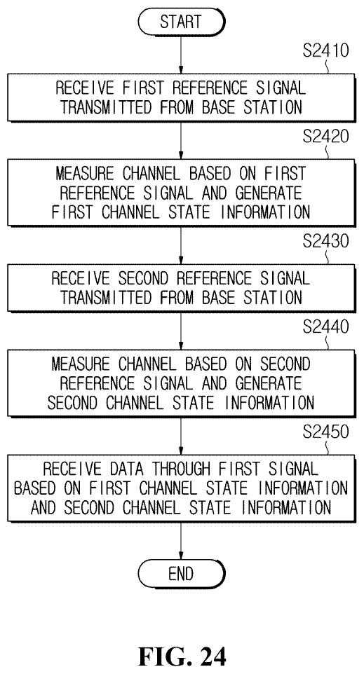

FIG. 24 illustrates an example of a signal transmission/reception procedure of a terminal in an SRE according to an embodiment of the present disclosure.

Referring to FIG. 24, at step S2401, the terminal may receive a first reference signal transmitted from a base station. The base station may transmit a first control signal to a RIS and then transmit the first reference signal. The first control signal may instruct that all the elements of the RIS should be off. When receiving the first control signal, the RIS may turn off all the elements of the RIS.

At step S2403, the terminal may measure a channel based on the first reference signal and generate first channel state information. As all the elements of the RIS are off because of the first control signal, the terminal may measure a direct channel between the base station and the terminal based on the first reference signal. That is, the first channel state information may be state information for the direct channel. Herein, the terminal may transmit the first channel state information to the base station according to a position of an integrated beamforming configurator (e.g., the base station or the terminal).

At step S2405, the terminal may receive a second reference signal transmitted from the base station. The base station may transmit a second control signal to the RIS and then transmit the second reference signal. The second control signal may include pattern information of the RIS. That is, the second control signal may instruct that at least one of the elements of the RIS should be on. The RIS may configure a pattern of the RIS based on the received second control signal.

At step S2407, the terminal may measure a channel based on the second reference signal and generate second channel state information. As specific elements of the RIS are turned on because of the second control signal, the terminal may measure a base station-RIIS-terminal channel according to the pattern of the RIS based on the second reference signal. Herein, as there is an impact of the direct channel, the second channel state information may be state information for an effective channel. Herein, the terminal may transmit the second channel state information to the base station according to a position of the integrated beamforming configurator (e.g., the base station or the terminal).

At step S2409, the terminal may receive data through a first signal based on the first channel state information and the second channel state information. Herein, the first signal may be a beamforming signal. As an example, a reflected channel value may be calculated by excluding the impact of the direct channel from the effective channel based on the first channel state information and the second channel state information. Based on the values of the measured direct channel, effective channel and reflected channel, integrated beamforming information may be determined. The integrated beamforming information may include information on an active beamforming value of the base station and a passive beamforming value of the RIS. As an example, in case the integrated beamforming configurator is located in the terminal, the terminal may determine and transmit beamforming information to the base station or the RIS without transmitting state information of each channel to the base station. As another example, in case the integrated beamforming configurator is located in the base station, the terminal may transmit state information of each channel to the base station, and the base station may determine beamforming information and transmit a passive beamforming value to the RIS. The terminal may receive data based on the determined beamforming information.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving a first reference signal transmitted from a base station;
measuring a channel based on the first reference signal,
generating first channel state information;
receiving a second reference signal transmitted from the base station;
measuring a channel based on the second reference signal,
generating second channel state information; and
receiving data through a first signal based on the first channel state information and the second channel state information,
wherein at least one of the first reference signal and the second reference signal is transmitted to a terminal through a reconfigurable intelligent surface (RIS).

2. The method of claim 1, further comprising:
receiving, from the base station, a first control signal that instructs the RIS to turn off all the elements of the RIS, and
receiving, from the base station, a second control signal that instructs the RIS to turn on at least one of the RIS elements,
wherein the first reference signal is transmitted with all elements of the RIS being off, and
wherein the second reference signal is a reference signal that is transmitted with at least one of the RIS elements being on.

3. The method of claim 2, wherein the second control signal is generated based on a learning result of a frequency rate according to a direction of the terminal.

4. The method of claim 2, wherein the second control signal comprises information that is generated through a codebook based on a RIS direction vector set.

5. The method of claim 1, wherein third channel state information is generated by the first channel state information and the second channel state information.

6. The method of claim 5, wherein the first channel state information comprises state information related to a direct channel,
wherein the second channel state information comprises state information related to an effective channel, and
wherein the third channel state information comprises state information related to a reflected channel.

7. The method of claim 1, wherein a first beamforming value and a second beamforming value are calculated by using the first channel state information and the second channel state information,
wherein the first signal is generated based on the calculated first beamforming value and the calculated second beamforming value,
wherein the first beamforming value is determined based on a beamforming value of the base station, and
wherein the second beamforming value is determined based on a beamforming value of the RIS.

8. The method of claim 7, wherein the terminal includes an integrated beamforming configurator to which an artificial intelligence (AI) technology is applied, and
wherein the first beamforming value and the second beamforming value are calculated by the integrated beamforming configurator.

9. The method of claim 8, wherein the integrated beamforming configurator has inputs of state information and a reward value based on reinforcement learning and outputs an action,
wherein the state information includes the first channel state information and the second channel state information,
wherein the reward value is determined based on a result for a control value of the RIS, and
wherein the action is determined based on the first beamforming value and the second beamforming value.

10-12. (canceled)

13. A terminal comprising:
a transceiver; and
a processor coupled with the transceiver,
wherein the processor is configured to:
receive a first reference signal transmitted from a base station,
measure a channel based on the first reference signal,
generate first channel state information,
receive a second reference signal transmitted from the base station,
measure a channel based on the second reference signal,
generate second channel state information, and
receive data through a first signal based on the first channel state information and the second channel state information, and
wherein at least one of the first reference signal and the second reference signal is transmitted to the terminal through a reconfigurable intelligent surface (RIS).

14. A base station comprising:
a transceiver; and
a processor coupled with the transceiver,
wherein the processor is configured to:
transmit a first reference signal to a terminal,
transmit a second reference signal to the terminal, and
transmit data through a first signal based on first channel state information and second channel state information,
wherein the first channel state information and the second channel state information are generated by the first reference signal and the second reference signal, and
wherein at least one of the first reference signal and the second reference signal is transmitted to the terminal through a reconfigurable intelligent surface (RIS).

15-16. (canceled)

17. The base station of claim 14, wherein the processor is further configured to:
transmit a first control signal to the RIS; and
transmit a second control signal to the RIS,
wherein the first control signal instructs all elements of the RIS to be off, and
wherein the second control signal instructs at least one of the element of the RIS to be on.

18. The base station of claim 14,
wherein the processor is further configured to:
receive information related to beamforming from the terminal based on the first reference signal and the second reference signal,
wherein information related to beamforming includes at least one of the first channel state information, the second channel state information, a first beamforming value and a second beamforming value,
wherein the first beamforming value is determined based on a beamforming value of the base station, and
wherein the second beamforming value is determined based on a beamforming value of the RIS.
